(19) United States
(12) Patent Application Publication
(10) Pub. No.: US 2008/0271070 A1
(43) Pub. Date: Oct. 30, 2008

(54) Negotiated access to promotional insertion opportunity

(75) Inventors: Chaitanya Kanojia, Waban, MA (US); Matthew B. Emans, Boston, MA (US); Lisa L. Lutz, Sudbury, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: NAVIC SYSTEMS, INC.

(21) Appl. No.: 12/150,322

(22) Filed: Apr. 25, 2008

Related U.S. Application Data
(60) Provisional application No. 60/926,488, filed on Apr. 27, 2007.

(51) Int. Cl. H04N 7/025

(52) U.S. Cl. 725/32

(57) ABSTRACT

A technique (and corresponding system) for controlling access to insertion opportunities in a multi-channel streaming media system is provided. The technique receives parameters for access to the insertion opportunities from multiple advertisers, such as desired audience viewership profile characteristics. The technique evaluates the received parameters to select which advertisers gain access to the insertion opportunities to place promotional content. The technique analyzes an audience of the placed promotional content and identifies which of the possible promotional content optimizes the value of the insertion opportunities or other maxima. Unlike traditional advertising in which advertisers pay per expected viewership, the technique may be arranged to charge advertisers only for a targeted audience that viewed the placed promotional content. The technique thus enables advertisers to access disparate insertion opportunities and to target an audience at lower cost without having to establish relationships with owners of insertion opportunities.

### CROSS REFERENCE TO RELATED APPLICATION

This application claims the benefit of U.S. Provisional Application No. 60/926,488, filed on Apr. 27, 2007. The entire teachings of the above application are incorporated herein by reference.

### BACKGROUND OF THE INVENTION

The present invention relates to providing access to insertion opportunities in a stream of video, such as may include advertising and other promotional insertion opportunities in a video stream, on a competitive basis.

For at least the past decade it has been common to transmit television programming and other broadcast entertainment to residences via digital technologies, such as via Digital Cable Television (CATV) networks, satellite links, digital radio broadcasts, video on demand (VOD), IPTV and broadband (internet based) video. The receiver devices (including television set top boxes) used with such networks now typically include embedded microcomputer systems that are designed for a particular function or purpose.

While their main function is to provide access to such video signals, these systems typically also have data logging and two way data communication capabilities with a server associated with the operator of the video delivery network. With the installation of software, such as that covered by U.S. Pat. No. 7,047,273, U.S. Pat. No. 7,330,824 and U.S. application Ser. No. 09/873,786 (all assigned to NAVIC SYSTEMS, INC., the assignee of the present application) these systems can report viewership behavior and can also be used for the deployment of, i.e., download and installation of, specific content. Such content may include promotional messages and other advertising targeted to specific homes. The promotional content can be downloaded and activated in various ways, among those as described in issued U.S. Pat. No. 6,845,396 assigned to NAVIC SYSTEMS, INC., the assignee of the present application.

### SUMMARY OF THE INVENTION

For many years, TV advertising has been placed across the handful of available broadcast channels by industry professionals (i.e., media buyers) directly negotiating buys of selected insertion opportunities (e.g, a commercial break available on specific channel at a specific time). Typically, the television networks and other inventory owners, on the one hand, and media buyers, on the other hand, would value the advertising time purchased using research data from companies such as Nielsen Media Research that is based on sampling the viewership from a limited number of households by. Research data was typically published as “ratings” and indicated a rough estimate of the number and the type of people watching each program. This approach enables advertising time to be manually bought and sold at either a fixed rate for a given insertion opportunity (e.g., spot purchases) or based on an agreed upon currency (such as an advertising buy that guarantees a certain amount of Nielsen ratings) when the number of options are relatively few and can still be measured by the collection of data from a relatively small sample (for example, a few thousand homes out of the overall US market of 100+ million homes). In recent years, the advertising industry has adopted electronic systems to make the placement and reconciliation of advertising orders more efficient, but these systems still rely on the same basic limited sample model and research data for the placement of advertising messages.

With the on-going deployment of digital distribution technologies and the launch of a multitude of new channels and more content (including high definition (HD) content), the TV viewing audience has significantly fragmented with small numbers of viewers consuming content from each channel or distribution method, often in numbers too small to be reflected by traditional sampling methodology. When this audience fragmentation is combined with further fragmentation resulting from new and alternate means to access video content through video-on-demand, digital video recorders (DVRs) and broadband video outlets, relying on traditional research and ratings to place and buy advertising becomes difficult and extremely inefficient, resulting in the under utilization of large segments of insertion opportunities to reach these fragmented audiences. Existing systems and methodologies also have difficultly effectively aggregating the fragmented audience of content viewers from both one-to-many and one-to-one (session based) insertion opportunities to meet an advertiser's marketing goals. By representing both one-to-many and one-to-one insertion opportunities as impressions, aggregated to be an audience, the system provides a novel approach to placing promotional content in various insertion opportunities.

Because audiences often tend to fragment into groups with like characteristics, this fragmentation actually represents an opportunity (at which this invention is directed) for an advertiser to more effectively place their promotional message if the audience available in these insertion opportunities (i.e., the number and type of actual viewers of the content offered in such insertion opportunity) can be effectively measured, characterized based on a variety of behavioral, viewership, demographic and other attributes, projected for the future and a promotional message can be matched to the available audience. To meet this need, it would be advantageous to control the deployment and insertion of promotional messages in a video stream in the most effective way from the perspective of the advertiser while at the same time enabling the owner of the insertion opportunity (e.g., a programming network or cable operator) to derive increased value for the audience represented by such opportunity. For example, advertisers could ideally identify a target audience by specifying the characteristics of that audience, such as geodemographic attributes and viewing or other behavioral characteristics, such that the advertiser could more effectively deliver their marketing message to this target group than general audience groups identified through typical research and media planning/buying techniques.

Such a system can analyze who has, is and will be watching a video stream when an advertising insertion opportunity is available, and then optimize the placement of media into such insertion opportunity by, among other things, identifying which of several different possible competing promotional messages will yield to one or more advertisers a combination of the highest targeted reach and most efficient media placement based on that advertiser's targeted audience characteristics and parameters, while at the same time providing the best value for the insertion opportunity based on the advertiser's or other content provider's budget parameters. More particularly, the system allows two or more advertisers to provide their promotional content, to specify desired target viewership demographic data and provide campaign goals including budget, reach, frequency and total impression goals.

At the same time, from the perspective of the owner of the insertion opportunity, the system also allows the various video providers that own or control these insertion opportunities, such as cable and satellite TV operators, programmers, broadcast stations, IPTV providers and broadband video outlets, to make their inventory of insertion opportunities available to the system according to the placement policies and parameters of the individual inventory owner. These business policies allow the owner of the insertion opportunity to control, for example, what types of media may be inserted into the insertion opportunity and at what rates and under what conditions the insertion opportunity is made available to the system for sale to advertisers using the system to place their promotions. By offering the end purchaser of the insertion opportunity (i.e., the advertiser or other content provider) with the accountability provided by measurement and the ability to optimally target specific audiences, the exchange system is able to provide added value to inventory of insertion opportunities provisioned by the owner into the exchange system. The inventory may be provisioned into the system on a consignment (i.e. pre-emptible) basis or as a fixed, pre-planned allocation from the inventory owner.

In addition, the exchange system offers owners of insertion opportunities the ability to make such insertion opportunities available to the system on an aggregate basis with owners of other insertion opportunities. This enables certain owners of insertion opportunities, such as a cable operator located in a specific city or a smaller or regional programming network, to make a compelling sales offering to a broader pool of content owners and advertisers than such owners can effectively reach today. Advertisers and content owners, especially those that are interested in reaching a wide audience, are more likely to place media on an insertion opportunity that may only appear in a certain region or within an insertion opportunity that has a relatively small reach, if that placement is part of a larger campaign that also includes placement on other insertion opportunities in different regions or on different programming networks. However, without a system that aggregates such insertion opportunities and allows advertisers and content providers to effectively place media on these disparate insertion opportunities as one or a limited number of media buys, the cost and effort of individually placing media buys with these disparate owners of insertion opportunities is often prohibitive.

With owners of insertion opportunities having made such insertion opportunities available to the exchange system and advertisers and content providers having selected the parameters for their media buys, the exchange system then evaluates the total set of advertiser campaign goals and other parameters, available insertion opportunities and any related owner parameters and the available audiences that are forecasted to view the content available in such insertion opportunity, selecting the solution which provides the best match for each advertiser's goals and other parameters, the available audience and the value of the inventory made available to the system. The optimization of the solution space of matching advertiser promotions to available insertion opportunities can be realized through various means and algorithms with different optimization maxima. The employed algorithms may be constructed to maximize one or more system parameters, or a combination of parameters, including but not limited to the value of the inventory made available to the system, the size of the target audience delivered to the advertiser or the spread between the cost of an inventory opportunity made available to the system and the effective sale price to the end advertiser.

In particular, with its capability to measure and/or forecast actual viewership of a given insertion opportunity and further optimize the placement of media thereon, the system is capable of negotiating a transaction between content providers and owners of insertion opportunities on differing economic or other terms. For example, the system would allow an advertiser or other content provider to purchase access to one or more insertion opportunities on an impression basis that takes into account actual viewership (e.g., buying at a rate expressed as a cost per thousand impressions (CPM)), while the owner of one or all of the insertion opportunities that are made available to the exchange system for sale, could make such insertion opportunities available to the system on a fixed price basis or on some other basis that does not take into account the actual viewership to determine the final price, with the system only consummating such a placement (and transaction between the parties) when the requirements of both of their parameters have been met.

The system then monitors the actual placement of promotional messages and the actual number of audience members that viewed the promotion or other content delivered. Thus, unlike traditional television advertising models, where advertisers pay for expected program viewership on a general demographic basis, the system can be implemented to charge the advertisers only for viewers who actually saw some portion of the promotion.

In addition, the regular measurement and estimation of actual viewership data, can be used to regularly apply corrections to the solution set as the actual delivered audience for each promotional message is measured.

The advertising exchange system can also include a centralized campaign management facility where advertisers create campaigns, load their promotional content, define target audiences, and monitor their budgets to achieve advertising objectives, allowing the system to provide a single point of access to multiple video outlets and insertion opportunities.

The system thus enables advertisers to access a precisely defined target audience, with automated accountability of delivered promotional impressions, and without the overhead of establishing relationships and executing orders for a multitude of insertion opportunities and inventory owners.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a high level diagram of the advertising exchange system, in accordance with an embodiment of the present invention;

FIG. 2 is a high level depiction of the distributed implementation of the system, in accordance with an embodiment of the present invention;

FIG. 3 is a high level overview of the system process, in accordance with an embodiment of the present invention;

FIG. 4 shows more detail of the inventory functional flow, in accordance with an embodiment of the present invention;

FIG. 5 is a flow diagram of a policy pre-emption process, in accordance with an embodiment of the present invention;

FIG. 6 illustrates a media buy data structure, in accordance with an embodiment of the present invention;

FIG. 7 illustrates the process to identify the solution dataset for optimization, in accordance with an embodiment of the present invention;

FIG. 8 illustrates the optimization engine process flow, in accordance with an embodiment of the present invention;

FIG. 9 is a high level diagram of a campaign design, in accordance with an embodiment of the present invention;

FIG. 10 illustrates different modes for running the optimization process, in accordance with embodiments of the present invention; and

FIG. 11 is a diagram of a process for verifying delivered impressions, in accordance with an embodiment of the present invention;

### DETAILED DESCRIPTION OF THE INVENTION

### I. Example Embodiment

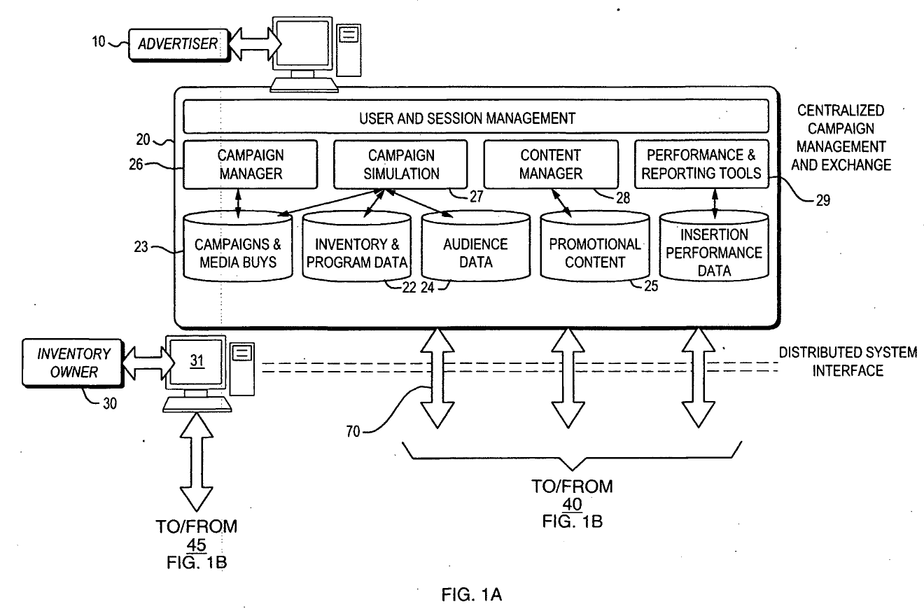

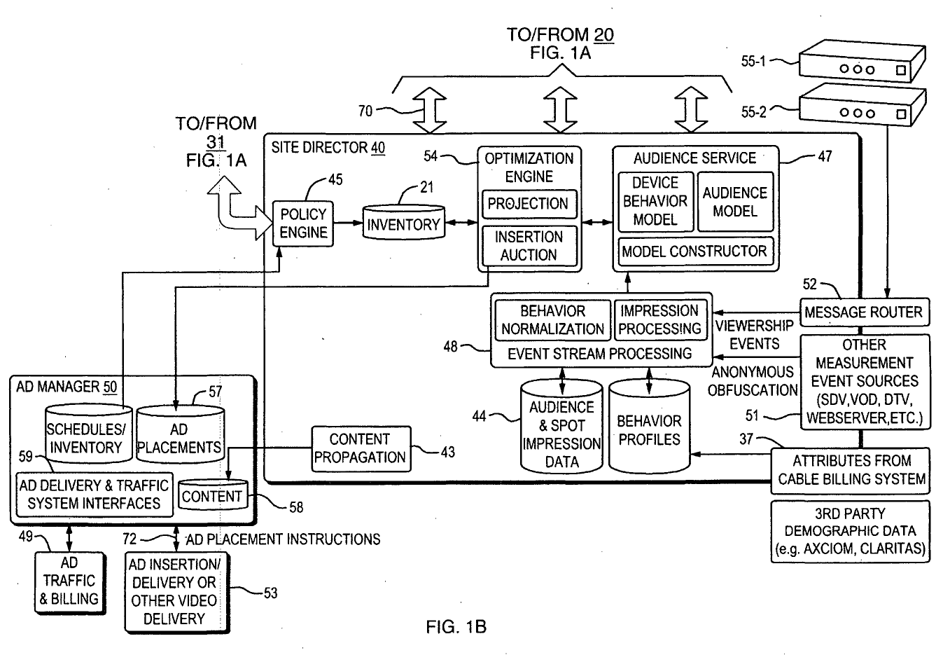

FIG. 1 shows a high level diagram of a data processing system, called an advertisement exchange system (referred to sometimes below as the “system”). In general, an advertiser (10) uses a centralized campaign manager (20) to specify the parameters associated with a media buy, which controls the insertion of the promotional content (such as an advertisement) into an insertion opportunity, including the characteristics of the target audience, target geography, impression delivery goals and campaign budget. The system will simulate campaign placements against projected inventory and audiences in real time to provide simulated results to the advertiser based on their input criteria and all the currently active media buys in the system. The advertiser may adjust the campaign criteria to achieve their desired results. Once a campaign is activated, the system will match advertiser promotions with insertion opportunities utilizing an optimization engine (54). The system constantly reevaluates the optimal solution set matching advertiser promotions with insertion opportunities based on audience delivery, changes to media buys, new inventory and updated measurement feedback, including obtaining viewership information from client devices such as set top boxes (55-1, 55-2, . . . 55-n) (referred to collectively as the set tops 55) via communication networking equipment such as a router 52 and other extraneous sources of viewership information (51), which may include sources such as Switched Digital Video servers, IPTV stream servers and VOD servers, among others. In one embodiment of this system, a client and server architecture is used to collect viewership information such as that covered in U.S. Pat. No. 7,047,273 “Load Balancing in Set Top Cable Environment and U.S. application Ser. No. 09/873,786 “Using Viewership Profiles for Targeted Promotion Deployment”, which are hereby incorporated by reference in their entirety.

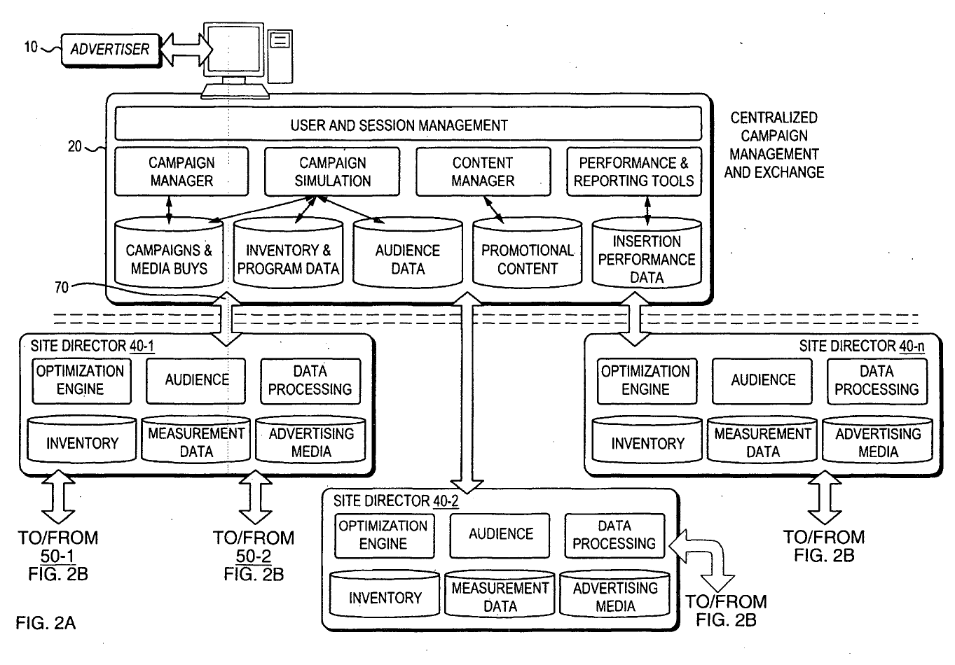

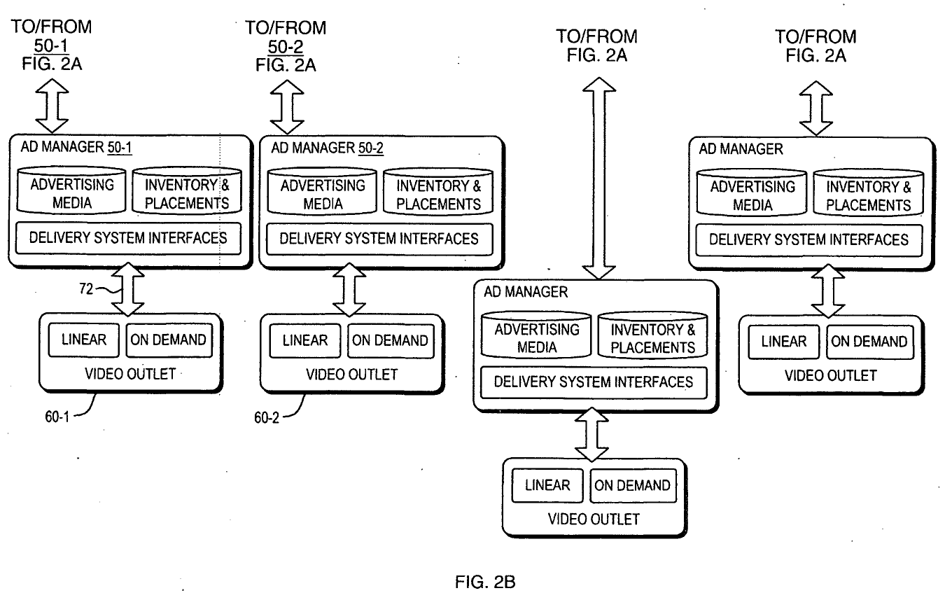

The system is designed to enable advertising placements across a typical national or global advertising market which includes hundreds of DMA (Direct Marketing Areas) and potentially billions of advertising insertion opportunities with thousands of advertisers accessing the system. As shown in FIG. 2, the system is implemented as a distributed computing system with three main tiers, where each tier communicates with the other systems via a set of programmatic interfaces (APIs).

The centralized campaign management and exchange systems (20) provide a central point of access for advertisers to access promotional insertion opportunities across all inventory represented by the system. These centralized systems provide the master control for advertising campaigns, content and access to inventory. This system provides the advertising user access to control their campaign and obtain campaign results. The central campaign management systems provide directives to the distributed systems regarding each of the advertiser campaigns to be fulfilled by the video outlets and insertion opportunities under the control of the distributed systems. These directives include media buy parameters such as target audience characteristics, program criteria and a subset of the total budget and impression goals allocated to the video outlets managed by the instance of the distributed system.

Distributed “site director” systems (40-1, 40-2, 40-n) is a set of systems is responsible for a set of insertion points and potential audience. These “site director” systems are connected to the central system (20) via a set of programmatic interfaces (70) which have been designed to allow distributed deployment of the system. The “site director” systems are responsible for the data processing required to interpret measurement events as an audience available for an insertion opportunity and the attributes and behavioral characteristics of that audience. The “site director” additionally manages the inventory of insertion opportunities made available by the video providers, both allocated and projected. The “site director” systems utilize the optimization engine (described in this invention) to match advertiser promotions against inventory made available by the video providers.

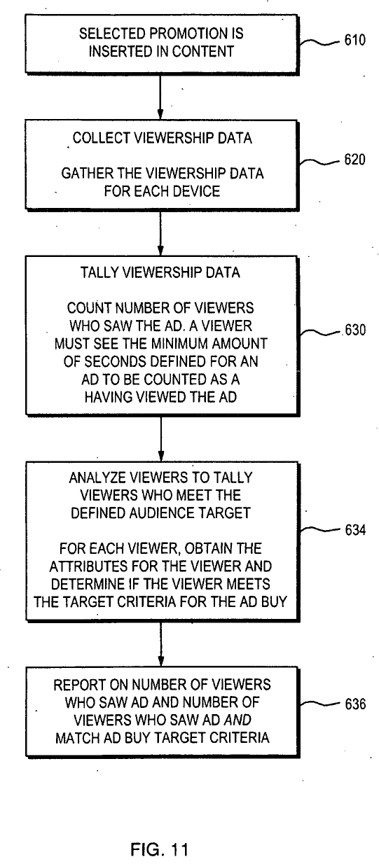

The “ad manager” systems (60-1, 60-2, 60-n) connect to the “site director” systems and provide the system the ability to implement promotional placement decisions at each of the video outlets participating in the exchange system. The “ad manager” systems interface to various inventory management and video delivery platforms (72) including ad traffic and billing (49), ad insertion systems (53), VOD systems, broadcast automation systems and web servers. The interfaces (72) with video and ad delivery platforms may be via proprietary means (e.g. schedule file transfer) or through industry standards, where available (e.g. SCTE-130 interfaces). These interfaces may also be leveraged for the system to obtain real-time notification of actual placement of promotional content in an insertion opportunity, allowing verification of actual viewership (see description of FIG. 11).

The “ad manager” is designed such that it may be co-located as necessary with the service delivery platforms and communicate via non-WAN enabled means to these systems. The “ad manager” may then communicate to the “site director” via secure WAN enabled interfaces such as web services (71). The “ad manager” contains a cache of ad placement decisions (57) such that it may continue to make ad placements s through a connection loss to the “site director” with the best known information.

The system (20) operates on several classes of data including an exchangeable inventory of insertion opportunities and associated programming data (22), campaign and media buy directives (23), audience data, both historical and projected (24), and promotional content with associated metadata (25) (such as, for example, the name of the advertising spot, the length of the advertising spot, the version of the advertising spot, etc.). This data is accessed by a campaign manager (26), an optimization simulation engine (27) which simulates the whole campaign for the benefit of the content provider's planning, but may be separate from the optimization engine which actually determines the placement of promotional content, and a content manager (28) to determine available inventory of insertion opportunities, associated audience size and characteristics and campaign delivery projections. Using these elements, the system is able to simulate projected placements of promotional content and campaign outcomes for the advertiser, allowing the advertiser to modify target selections, content restrictions, budget and impression goals until their objectives will be met by the campaign. The results of the projected placement of promotional content is displayed to the advertiser through a web-based user interface with a variety of analysis options showing distribution and characteristics of the audience reached, programming placements and other relevant data. Once a final set of these media placement criteria has been selected by the advertiser, the advertiser will approve a media campaign to be executed by the system. The system may allow the advertiser to revise these placement criteria throughout the course of the campaign. Based on the applicable video outlets to be covered by the campaign, the content manager (28) will propagate the promotional content from the central content store (25) to the each appropriate ad managers' content stores (58) from which it is transferred to the ad delivery system (53).

Once a campaign is executed, information concerning the desired criteria for placement of advertiser campaigns and promotions is then fed to the “site director” systems (40). These systems obtain an inventory of insertion opportunities through interfaces (59) with traffic and billing (49) or other inventory managers for the video outlets, process this inventory of insertion opportunities per a set of business rules using a policy engine (45), making the inventory of insertion opportunities available for matching with advertiser promotions. The inventory owner (30) uses an interface provided by the system (31) to set and revise the policies which govern the types of inventory and rates for the inventory which are made available to the system.

Measurement of viewership and other events from settops or other video outlets, via a message router (52) or other sources of measurement data (51), are processed by the system. These measurement events and other settop attributes may be processed to keep a consistent yet anonymous profile of a settop device to conform to privacy policies for the industry. Measurement event processing (48), which may occur in real-time, includes normalization against known behavior profiles and insertion events. This data is processed to construct a model of the audience which is used to identify the size and characteristics of the audience available for each insertion opportunity. Based on event data from the devices being measured, the system constructs a model which provides forecasts of audience size and characteristics for future insertion opportunities. The system constructs a model (47) of current and forecasted future audience for each insertion opportunity utilizing various quantitative analysis techniques relying on historical viewership data, program metadata and audience attributes. This model may be queried by other elements in the system for forecasted or current audience including the optimization engine (54) and campaign simulation (27) components. One embodiment of this system uses M5 rules and linear regression techniques to construct the audience model from the data sources mentioned above.

Data on audience behavior profiles and impressions against promotional insertions is recorded and stored (44) for future analysis using reporting tools (29) and construction of audience models. Qualification of measurement data to audience impressions for a particular insertion event may include various heuristic processing to qualify actual audience exposed.

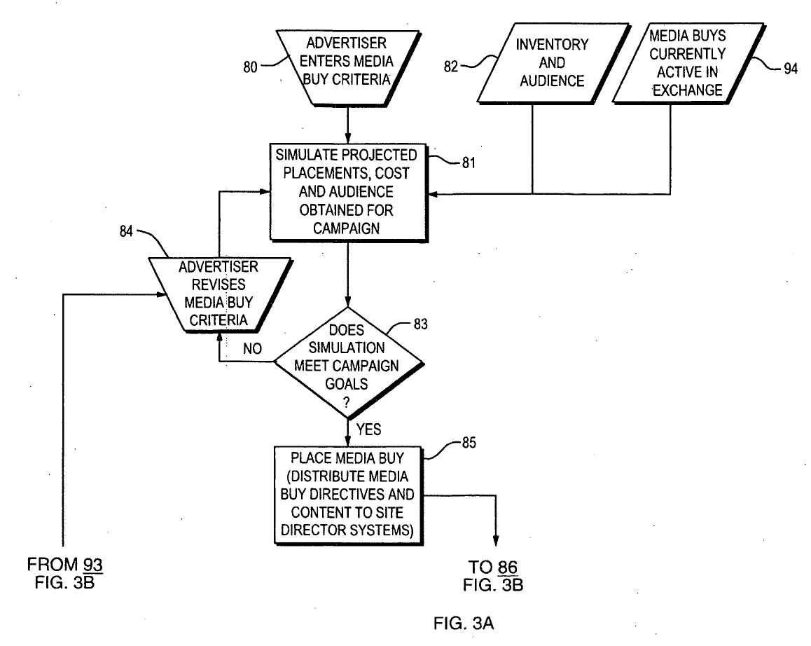

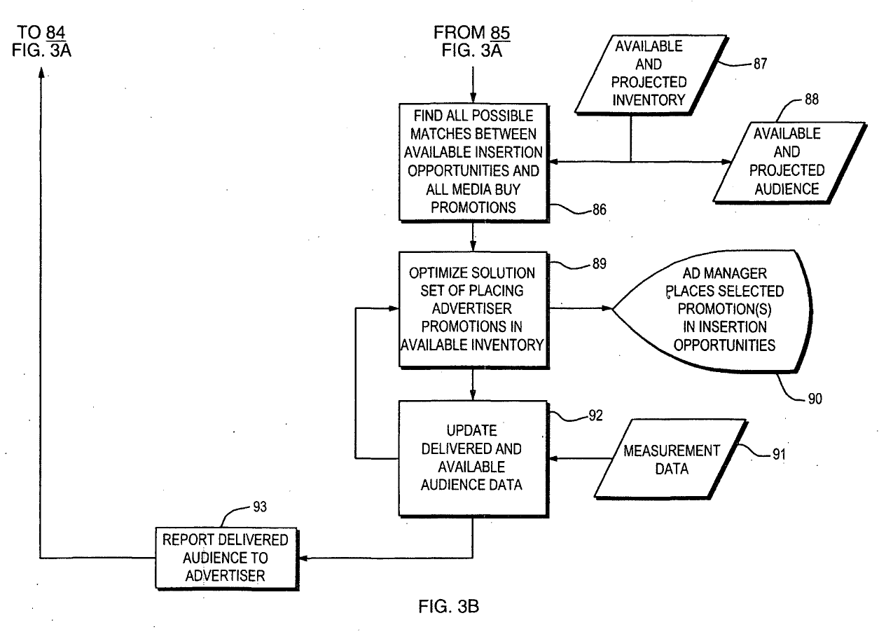

FIG. 3 depicts the overall process flow for the exchange system. In this figure, the advertiser enters media buy criteria (80) into the system including target audience, budget and impression goals as described above. Using data on available projected audience and inventory (82) and currently active media buys in the exchange (94), the system simulates (81) the projected placements for the campaign and the audience exposed by the advertiser's promotional content based on those projected placements. The campaign simulation provides a projected result for the advertiser in real time based on projected audience and inventory availability. This simulation may make certain approximations, such as the aggregate impressions available in a certain program, to complete the simulation for the specified length of the campaign (usually several weeks to months). The results of the simulation are shown to the advertiser and the advertiser may select to revise these input criteria (84) or activate the media buy (85). Activating the media buy places the directives for that advertiser into the overall exchange and optimization process run by the system. The first step in this process matches (86) the advertiser's media buy against all known and projected inventory (87) (insertion opportunities) which match the advertiser's criteria (see FIG. 7 for a more detailed description of this process) and obtain audience estimates for each matching piece of inventory (88). These audience estimates will include both the number of impressions available for the insertion opportunity and the projected proportion of the audience which meets the targeting criteria of the media buy. This matched data set represents the total possible solution space for placing advertiser promotional content into available insertion opportunities. The system typically employs an ongoing, iterative optimization algorithm (89) to find the optimal placement of advertiser promotions in the total of known available and projected insertion opportunities. Execution of the optimization algorithm can additionally be invoked on an on-demand basis by external events, such as the addition of new inventory to the system or the initiation of a video stream containing insertion opportunities, such as a Video On Demand session.

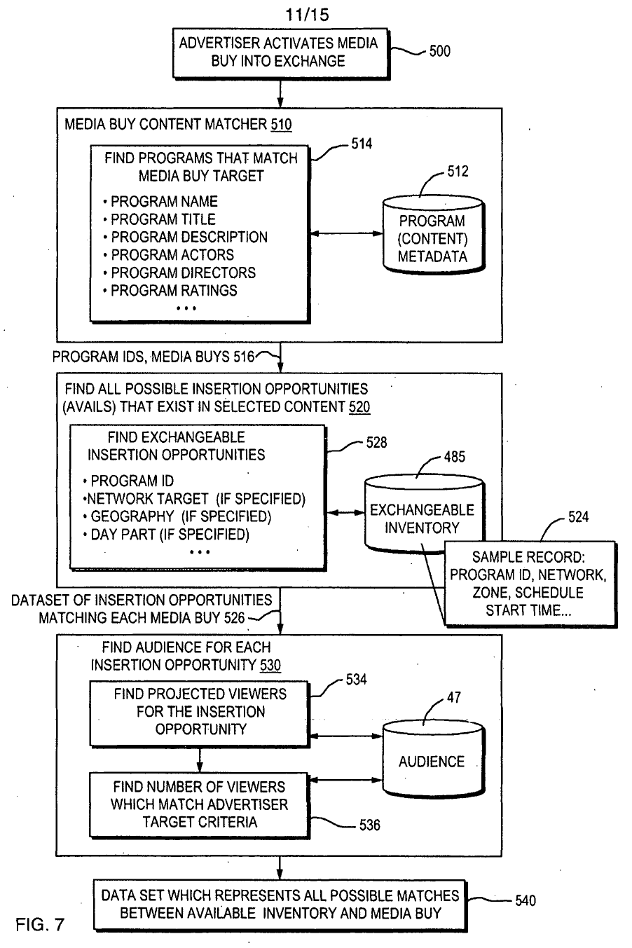

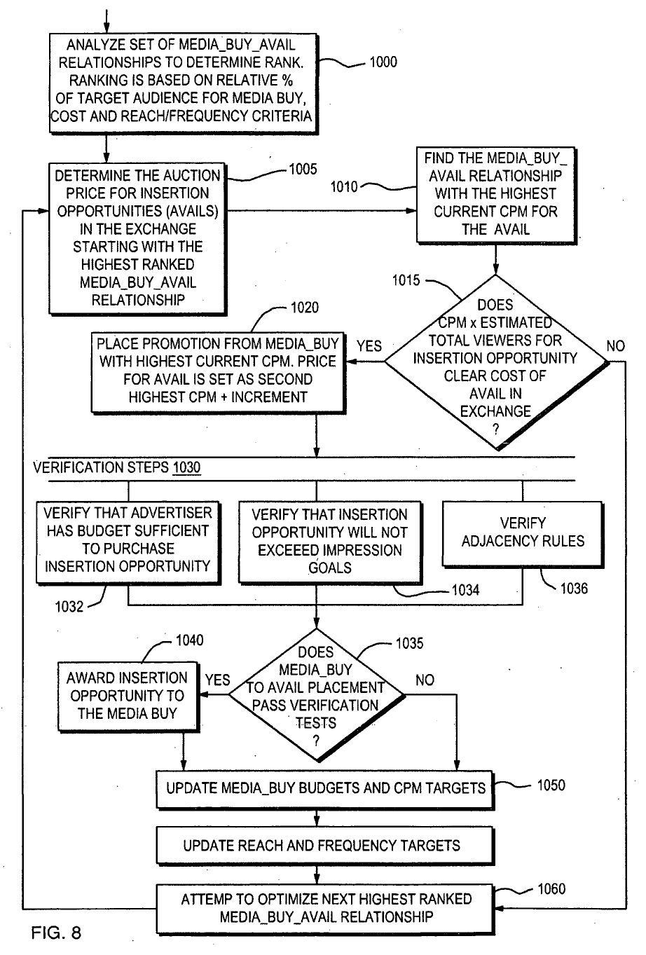

This optimization algorithm is constrained by an inventory rate or other relevant parameters assigned by the inventory owner, the budget available in each of the active media buys and the impression goals of each media buy. The set of possible solutions which represents the valid matches between the available insertion opportunities and media buys is very large; the optimization engine utilized by the system may be constructed as to select solutions which maximize one or more values or scores derived from the selected solution. For example, the optimization engine may be constructed to maximize the value of the inventory realized through the system or to maximize the number of targeted viewers delivered to the advertisers for their budget. Optimization algorithms could also be constructed to maximize the total number of impressions delivered to advertisers for their budgets. Some additional details of a particular embodiment of the optimization algorithm are provided in conjunction with FIG. 8 below.

Once the system has selected a particular optimal placement solution based on current conditions (89), the Ad Manager is instructed to place promotional content (90) per the selected solution set. Measurement data is collected (91) as the system operates and promotions are placed in insertion opportunities. This data is used to update the system's data on audience delivered in each insertion opportunity and the available audience for future insertion opportunities. This information is fed back into the optimization engine (89) along with updated availability of inventory and a new solution may be selected from the set of possible solutions based on updated information. The system may run the optimization algorithms continuously or on-demand, selecting new solutions as dictated by the operational conditions and changing inputs to the exchange of inventory, available audience and media buys.

The system will report delivered audience and updated projections to the advertiser as required (93), allowing the advertiser to revise their media buy (84) if required.

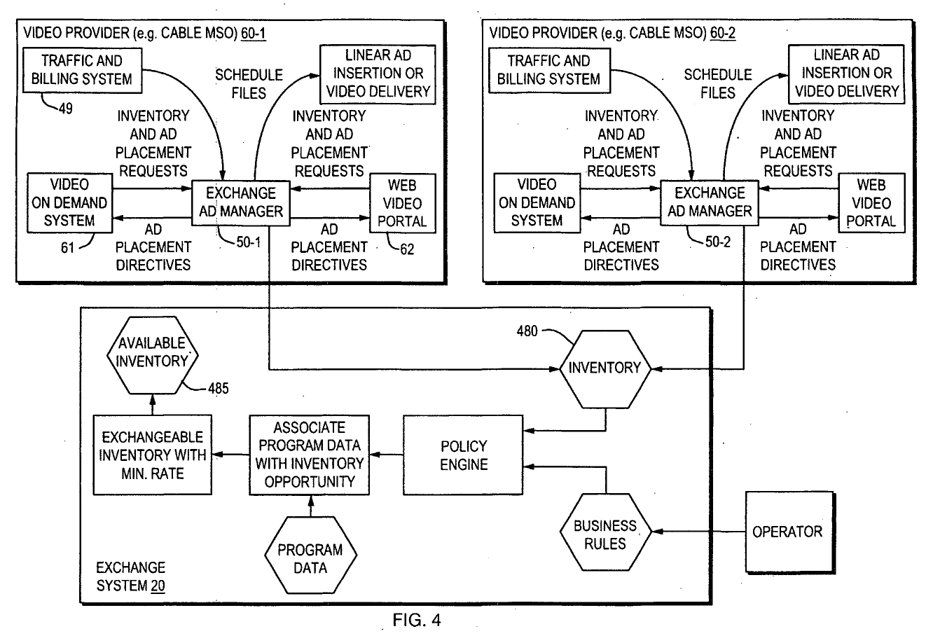

As shown in FIG. 4, it is possible with the system (20) to aggregate insertion opportunities (inventory) from and control and optimize placement of promotional content in insertion opportunities for multiple video providers across multiple formats. As shown in FIG. 4, the system can control insertion opportunities for both one-to-one session based video streams (such as VOD, broadband or IPTV) and for one-to many video streams by optimizing the value of the audience represented in each insertion opportunity.

The insertion opportunities can be defined by a broadcast time, a channel, a digital video recorder (DVR) placement opportunity, video on demand (VOD), a video stream from a broadband video portal or in other ways. Insertion opportunities may occur during segments of content (interstials) or before or after content (pre-roll and post-roll).

Thus, it is seen that the example cable site (60-1) provides both linear insertion inventory (for example, as schedule files from the traffic and billing system (49)), VOD inventory from the VOD system (62) and inventory from a broadband video portal (62) to the exchange system through the ad manager system (50-1, 50-2). It should be understood that although the examples discussed for this preferred embodiment are for use in a cable television network, the corresponding features can be deployed in other providers of video content for entertainment including broadcast television networks, satellite networks, IPTV and broadband video portals (e.g. NBCU's Hulu). The ad manager system (50) in turn provides inventory records, i.e., records of available DVR, VOD, time and channel or broadcast insertion opportunities to an inventory database (480), which is part of the system (20). Inventory database (480) thus eventually represents a list of available insertion opportunities throughout one or more of video outlets (60). This inventory of insertion opportunities, called the list of “Avails”, thus represents the available inventory of insertion opportunities that may be matched to advertiser promotional content managed by the system.

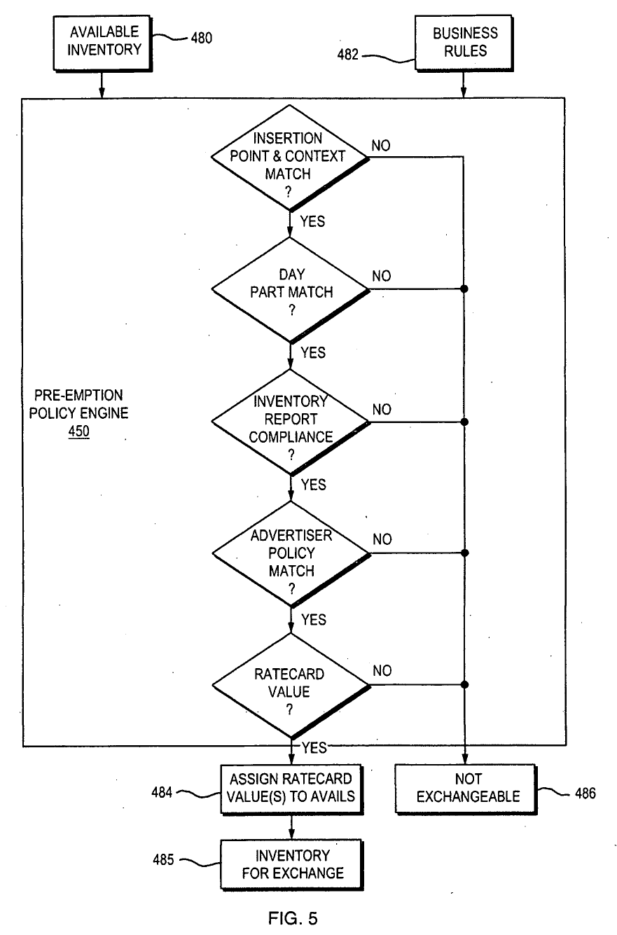

As shown more particularly in FIG. 5, this Avail inventory (480) and the corresponding business rules (482) which are entered by the inventory owner, can then be used to determine whether each item of inventory can actually be eligible for the optimization process (i.e., exchanged)—resulting in a list of exchangeable inventory (485) and not-exchangeable inventory (486). To determine whether an Avail can be exchanged, one or more tests are performed by a business rules policy engine (450). These tests can include insertion point and context match, date and time match, inventory report compliance, advertiser policy match, and rate card value check. In step (484), the inventory of Avails is assigned a value as specified by the ratecard which is part of the business rules (482) defined by the inventory owner. Insertion opportunities (inventory) may be provisioned into the system on a consignment (i.e. pre-emptible) basis or other monetary condition on which the Avail may be exchanged. Alternatively, Avails may be made available to the system by the owner of the insertion opportunity on a fixed, pre-planned allocation from the owner of the insertion opportunity. The result is a list of exchangeable inventory (Avails) (485) that can be used for negotiated transactions.

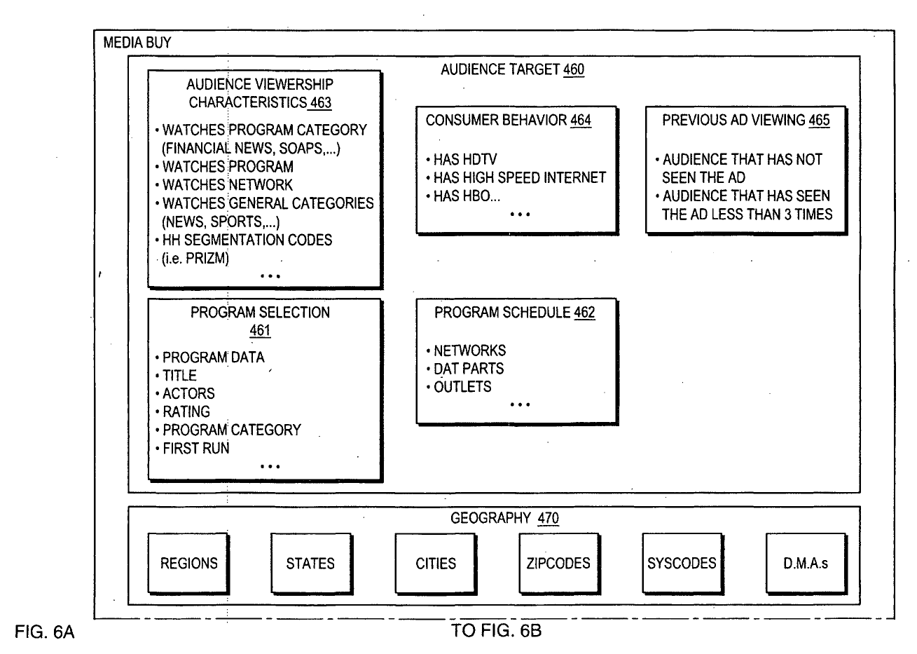

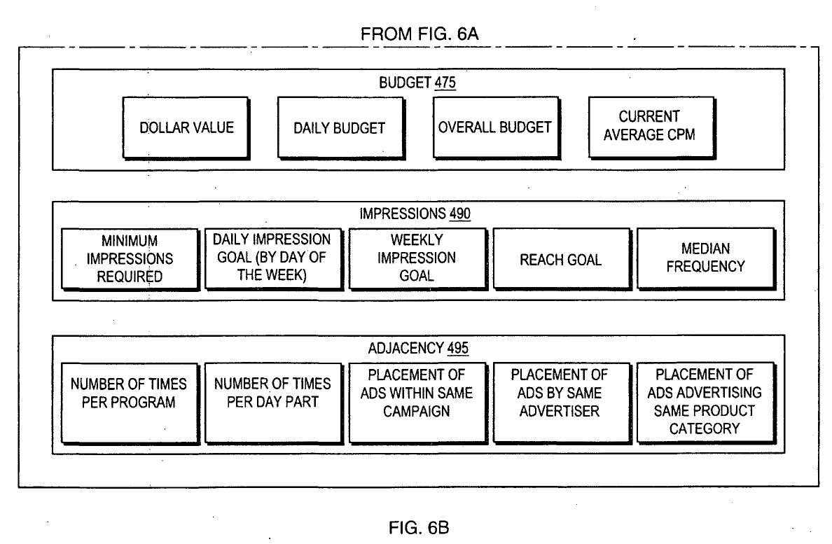

FIG. 6 illustrates a typical data structure that describes the parameters associated with a media buy in the exchange system. These may include fields such as an audience target specifier (460) that includes content selection data (461) (e.g., program data, title, actors, program rating, program category, user rating, whether it is the first run of such program, etc.), content schedule information (462) (such as networks and the time(s) and date(s) in which the promotional content is permitted to run), and desired audience viewer profile characteristics (463). Viewer profile characteristics can include attributes derived from viewing consumption (such as whether the desired user watches the program category, the particular program, the network general categories) viewing behavior (such as how often channels are changed or various electronic features are activated on the settop), geodemographic codes associated with the viewer (such as PRIZM codes), consumer behavior information (464) (such as whether the viewer has a high definition television set, high speed internet access, has access to particular pay networks, such as HBO and the like), or other household segmentation attributes. The audience target can also contain information on previous viewing of the promotion, providing a method to control frequency of ad exposure for the targeted audience, and other relevant parameters such as the advertiser designating “popularity” parameters selected from a group consisting of, for example, “all top rated shows”, “top rated sports shows”, “highest rated show in a particular time slot”.

A geography data field (470) can also define the desired or required geographic placement of a media buy, including desired regions, states, cities, and zip codes for ad deployment.

Campaign and media buy budget data (475) can include Cost Per Thousand Impression (CPM) dollar value to be applied over the campaign or some finite time period, a daily (or other fixed time period) budget, and overall campaign budget information as well as selected promotional content for insertion.

Impression count fields (490) can also be included within the data structure of the media buy parameters, including minimum impressions required, maximum number of impressions and other campaign goals, including reach and frequency goals. In addition, adjacency fields (495) are parameters that can further define and/or limit the placement of a promotion based on the placement of other advertising (whether also placed by the exchange system or not), including the number of times the content of the media buy is placed per program, the number of times the content of the media buy is placed per day, placement of advertisements within the same category, placement of advertisements by the same advertiser, and the placement of advertisements advertising the same product category information. The parameters of a media buy can also include information concerning desired cost and distribution of the promotional content to a specific audience, and may include still further detailed information, such as shown in FIG. 6.

FIG. 7 and FIG. 8 show an example embodiment of the optimization engine represented in FIG. 3 in (86) and (89). FIG. 7 is a sequence of steps that can be performed to determine whether a media buy for the particular “audience” represented by the media buy parameters will be accepted.

Once an advertiser activates a media buy in step (500), placing that media buy into the exchange, then a media buy content matcher process (510) find programs that match the media buy target. The media match may be performed by accessing a datastore (512) containing program or content metadata to determine media that matches the desired program name, title, description, actors, directors, program ratings and the like.

The foregoing produces a list of program ID's that would possibly satisfy the media buy as output (516).

In step (520), the process continues to now determine all the insertion opportunities that exist in the content selected to in step (510). This can be done by searching the inventory of available insertion opportunities (485) that have been derived as described above and shown in FIGS. 4 and 5 to determine the available insertion opportunities by a program ID, as well as a network target, geography, day part or any other parameters, if the fields for these parameters are also specified. A sample inventory record (524) is shown that includes a program ID, a network zone, i.e., geographic zone, schedule start time, and other parameters for the placement. The resulting dataset (526) represents the set of valid matches between available insertion opportunities and each media buy.

As the next step (530) in the process, the audience model (47) is queried to determine the projected number of viewers (534) for the insertion opportunity. If the video stream has started or is about to start (e.g. VOD play), the actual number of measured viewers can be input into the model; if the insertion opportunity is in the future, the model produces a projected number of viewers for the insertion opportunity. The system also identifies the number of viewers (536) which match the advertisers audience target. This process is completed for each media buy which is active in the exchange system, the output of this process being a data set (540) which represents the complete set of matches between available insertion opportunities, media buys and the projected audience for each one. In each relationship between a media buy and an insertion opportunity, the number of viewers which match that advertiser's target criteria is represented.

FIG. 8 depicts the logic for a particular embodiment of the optimization algorithm as a 2nd price auction. The depicted process starts in step (1000), operating on the data set of relationships between media buys and avails which was produced as described above and identified as (540). Step (1000) analyzes the set of media_buy_avail relationships for each media buy and assigns a score to each one to allow each relationship to be ranked in order of relative value for the media buy. Various methods can used to derive the score with inputs including reach (size) of delivered audience, relative percentage of target audience compared to other avails, expected cost of the avail, probabilistic correction for audience and inventory availability and the like.

In step (1005) the auction proceeds by attempting to auction the avail_buy_relationship with the highest score in the exchange from step (1000) to the highest bidder. In step (1010), the media_buy_relationship with the highest current CPM (from the media_buy data object) is selected to be awarded the insertion opportunity. Step (1015) checks if the media buy can pay the rate defined by the inventory owner when the inventory was provisioned into the exchange. If the media buy can pay for the avail, the media buy is awarded the avail at some increment over the price that would have been paid by the second highest bidder in the auction (1020). In step (1030), a number of verification checks are made to ensure that the insertion opportunity can be awarded to the selected media buy. Several tests can be performed, such as in step (1036) to determine if the Avail meets adjacency rules, if the Media buy has a daily or overall budget amount remaining (1032). If the placement of the media buy in the avail passes the required verification checks (1035), the insertion opportunity is awarded to the media buy. The ad manager for the video outlet is informed of the placement decision as described previously.

In step (1050), the media buy budget and current CPM targets are updated based on awarding the insertion opportunity to the media_buy. In step (1060), the auction returns to optimize the next highest scored media_buy_avail relationship in the exchange. It is understood that the optimization process described in FIGS. 7 and 8 is preferably a continuous process such that auctions are continuously run again to optimize the solution of matching insertion opportunities to media buys. The optimization process described herein can additionally be invoked in an as-needed basis by external events including the addition of new media buys, the addition of new inventory or the initiation of a video stream with embedded insertion opportunities.

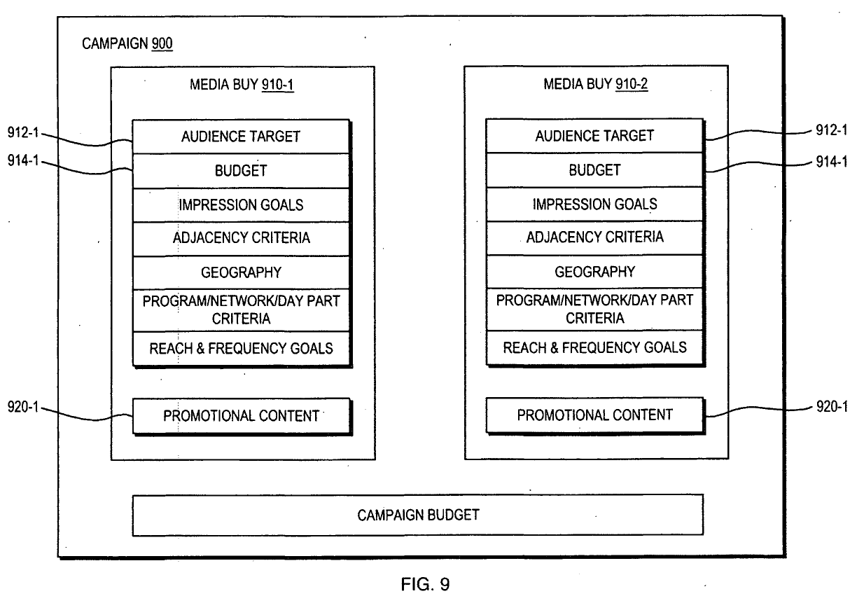

As shown in FIG. 9, a particular campaign (900) may exist may consist of multiple media buys (910-1, 910-2, 910-n) wherein each media buy specifies a separate audience target (912-1, 912-2), budget (914-1, 914-2) and separate promotional content (920-1, 920-2) as has been described above.

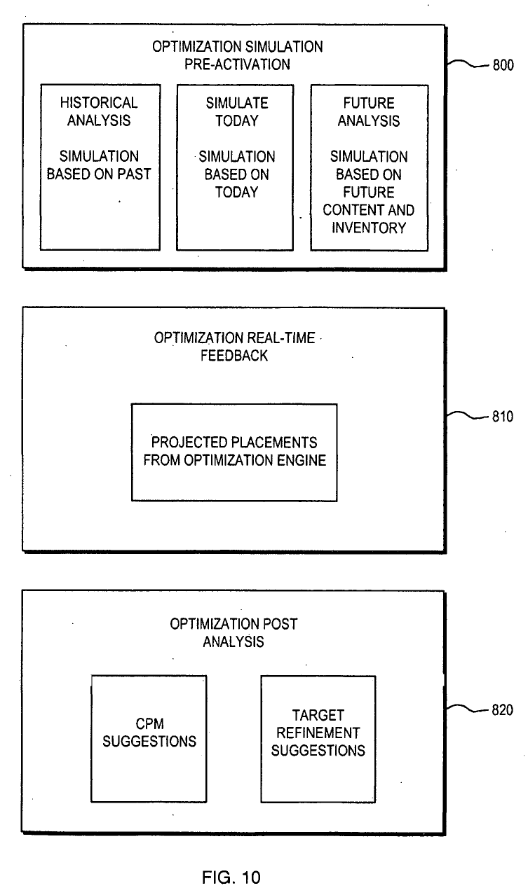

FIG. 10 illustrates possible optimization modes, including pre-optimization simulation (800) real-time feedback (810) and post analysis (820).

FIG. 11 illustrates the process for posting the actual delivered impressions for promotions placed in insertion opportunities (610). This can be by first collecting viewership data in step (620) for each device which may have viewed the inserted promotion, tallying viewership data in step (630), which includes applying any editing rules such as minimum promotion exposure length or rejection for inactive viewing.

In step (634), the specific devices exposed to the promotion are additionally analyzed to determine if they match the advertiser's audience target criteria, and in step (636), a report is made on the number of viewers who actually saw the ad and the number of viewers who saw the ad and matched the target by criteria. This gives a count of actual impressions that matched the Media buy. This report gives the advertiser both a level of verification on the number of viewers that ultimately viewed their promotion, as well as an understanding of the level of efficiency and accountability in knowing how many viewers in their target audience that they reached.

### II. Additional Design Alternatives

The following is a discussion of several considerations that one may wish to take into account when implementing the AdExchange system (20). While it should be understood that the above description is sufficient to practice a preferred embodiment, the material presented below may further assist with implementing a useful system.

1. Integrated System

For certain applications, rather than implement the exchange system as a distributed computing solution as identified in FIG. 1 and FIG. 2 with separate centralized campaign management (20) and distributed “site director” systems (40), the system may be implemented as a integrated solution wherein the components of the centralized campaign management (20) and “site director” systems (40) may be integrated into a single system. This embodiment of the invention provides an exchange system which could be utilized for smaller pools of inventory and numbers of video outlets, e.g. on limited local or regional basis. The interaction between the various internal system components and processes remains as described in the previous sections.

2. Centralized Optimization Engine

An alternate implementation of the system may implement the optimization engine as part of the central exchange and campaign management system (20) rather than as part of the distributed “site director” systems (40). The implementation described with FIGS. 1, 2 and 3 above relies on parceling out budget, target and impression goals to individual site directors responsible for particular video outlets or markets based on the campaign simulation. The alternate implementation allows insertion opportunities to be optimized across different video outlets or regions in a single engine with a simpler algorithm but does not scale as well to large numbers of markets, video outlets and large amounts of inventory to be processed by the system. In this implementation, the optimization process remains as described in FIG. 3, with the exception that the set of possible insertion opportunities operated on in (86) and (89) is collected from all of the video outlets participating in the exchange instead of just those managed by a particular “site director” (40).

3. Pre-Defined Audiences

The system described in the preferred embodiment allows the advertiser to uniquely define the target audience by combining any number of target criteria. Alternately, the system (20) can have predefined audiences that are defined by the administrator of the exchange system and can be used in any media buy. Pre-defined audiences can simplify the process for entering and executing a media buy for less sophisticated users, such as a small business, which does not normally place video advertising on TV. Additionally, certain attributes can be combined based on audience research to describe a particular audience which advertisers may wish to reach such as “likely homebuyers” or “stay-at-home moms”. Thus, supplying pre-defined audiences may simplify the buying process using the system and enhance the targeting provided to advertisers.

The definition of standard audiences can also streamline the processing of optimization simulations and media buy placements by allowing target audience models to be run be run automatically each day and have cached values which will allow for quick analysis—including efficiency, number of total viewers, number of targeted viewers, tallied by daypart/network, and even the program data.

3. Ratecards and Commissions

As described above, the inventory owners participating in the exchange are able to identify insertion opportunities which they wish to make available for the exchange using a policy engine (45). When inventory is added to the system, the inventory owner (video outlet) will identify either a minimum or fixed rate to offer the inventory into the exchange. As part of the ratecard for each inventory owner and class of inventory, the system can also keep track of a commission for each ad placed through the exchange. Commissions can be based on flat rates or percentages. In addition to the minimum rate, it is possible that the Avail may sell for some amount above the minimum clearance rate. This can happen if there are multiple advertisers bidding for the same avail.

Also, the exchange can track different rates and different pools of inventory for different advertisers. In this implementation, the inventory owner is able to specify certain classes of inventory to be made available to certain advertisers at different, often discounted, rate. In this manner, the inventory owner can offer special incentives to certain advertisers for purchasing inventory.

While this invention has been particularly shown and described with references to preferred embodiments thereof, it will be understood by those skilled in the art that various changes in form and details may be made therein without departing from the scope of the invention encompassed by the appended claims.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the invention.

It should be understood that elements of the block, flow, and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of computer readable medium, such as random access memory (RAM), read only memory (ROM), compact disk read only memory (CD-ROM), and so forth. In operation, a general purpose or application specific processor loads and executes the software in a manner well understood in the art.

What is claimed is:

1. A method for controlling access to insertion opportunities in a multi-channel streaming media system comprising:
receiving parameters for a negotiated transaction for access to insertion opportunities from multiple promotional content providers; and
determining based on the received parameters for the negotiated transaction which promotional content providers gain access to the insertion opportunities to place promotional content.

2. A method as in claim 1 wherein receiving the parameters includes receiving one or more of: i) audience target data, ii) geography data, iii) budget data, iv) impressions data, v) adjacency data, and vi) reach and frequency data.

3. A method as in claim 1 wherein the step of receiving includes receiving information concerning desired audience viewership profile characteristics, the received information includes one or more of: i) whether the audience watches specific programs or program genres, ii) geodemographic attributes, and iii) household segmentation attributes, and iv) other data derived from actual audience viewership.

4. A method as in claim 1 wherein the step of receiving includes receiving information concerning consumer behavior of an audience, the received information includes one or more of: i) devices owned by the audience and ii) services subscribed to by the audience.

5. A method as in claim 1 wherein the step of receiving includes:
simulating placing promotional content using a projected audience and projected insertion opportunities to obtain projected results of placing the promotional content; and
revising the received parameters based on the projected results obtained.

6. A method as in claim 1 wherein the step of determining includes:
matching the received parameters against the insertion opportunities to produce a total set of matches representing possible placement of promotional content in the opportunities; and
evaluating the produced total set of matches by using audience estimates obtained for each match to produce a selected set of matches that maximizes one or more of: i) value of the insertion opportunities, ii) targeted audience delivered to the promotional content providers for their budgets, and iii) total audience delivered to the promotional content providers for their budgets.

7. A method as in claim 1 wherein the step of determining includes given a total set of matches between the insertion opportunities, the received parameters, and audience estimates, selecting matches that maximize one or more of: i) value of the insertion opportunities, ii) targeted audience delivered to the promotional content providers for their budgets, and iii) total audience delivered to the promotional content providers for their budgets.

8. A method as in claim 7 wherein the step of selecting includes:
assigning values to the insertion opportunities to represent the relative values of the insertion opportunities to the promotional content providers; and
awarding a subject insertion opportunity to a subject promotional content provider so that a value of the awarded subject insertion opportunity to the subject promotional content provider is the highest amongst other insertion opportunities available.

9. A method as in claim 8 wherein the step of assigning includes assigning values to the insertion opportunities on an individual basis to represent the relative value of each insertion opportunity to the promotional content providers on an individual basis.

10. A method as in claim 8 wherein the step of assigning includes deriving values from one or more of: i) reach of delivered audience, ii) relative percentage of target audience compared to other insertion opportunities, iii) expected cost of the insertion opportunities, and iv) error correction terms based on a probability that projected audiences and insertion opportunities will be available.

11. A method as in claim 1 wherein the step of determining includes determining which promotional content providers gain access to the insertion opportunities to place promotional content until a number of impressions paid for by each promotional content provider is reached.

12. A method as in claim 11 wherein the number of impressions includes: i) an audience who viewed promotional content placed in the insertion opportunities or ii) an audience who viewed promotional content placed in the insertion opportunities and match the received parameters.

13. A method as in claim 1 wherein the step of determining includes reconciling selling the insertion opportunities in terms of cost for the insertion opportunities with buying the insertion opportunities in terms of cost for a number of impressions.

14. A method as in claim 1 wherein the step of determining includes determining which of the insertion opportunities can be accessed by the promotional content provider to place promotional content based on one or more business rules that dictate placing promotional content into the insertion opportunities.

15. A method as in claim 1 wherein the insertion opportunities are defined by one or more of: i) broadcast time, ii) broadcast channel, iii) Digital Video Recorder (DVR) slot, iv) Video on Demand (VoD) stream, v) Internet Protocol Television (IPTV) access message or vi) broadband video portal.

16. A method as in claim 1 further comprising:
updating the parameters for the negotiated transaction for access to an other insertion opportunity based on audience measurements that relate to placing promotional content in the insertion opportunity; and
re-determining based on the updated parameters for the negotiated transaction which promotional content providers gain access to the other insertion opportunities to place promotional content.

17. A method as in claim 16 wherein updating the parameters includes updating the parameters based on one or more of: i) an audience who watched the placed promotional content, ii) an audience who watched the placed promotional content and matched the received parameters, and iii) data from a third party.

18. A method as in claim 1 further comprising accounting for placement of promotional content with one or more of: i) an audience who watched the placed promotional content, ii) an audience who watched the placed promotional content and satisfied the received parameters, and iii) data from a third party data.

19. A method as in claim 1 further comprising receiving the insertion opportunities on: i) a pre-emptible basis in which a monetary or business condition is set, or ii) a pre-planned allocation of the insertion opportunities, or iii) a fixed monetary basis.

20. A system to control access to insertion opportunities in a multi-channel streaming media system comprising:
a receiving unit to receive parameters for a negotiated transaction for access to insertion opportunities from multiple promotional content providers; and
a determining unit coupled to the receiving unit to determine based on the received parameters for the negotiated transaction which promotional content providers gain access to the insertion opportunities to place promotional content.

21. A system as in claim 20 wherein the receiving unit receives one or more of: i) audience target data, ii) geography data, iii) budget data, iv) impressions data, v) adjacency data, and vi) reach and frequency data.

22. A system as in claim 20 wherein the receiving unit receives information concerning desired audience viewership profile characteristics, the received information includes one or more of: i) whether the audience watches specific programs or program genres, ii) geodemographic attributes, and iii) household segmentation attributes, and iv) other data derived from actual audience viewership.

23. A system as in claim 20 wherein the receiving unit receives information concerning consumer behavior of an audience, the received information includes one or more of: i) devices owned by the audience and ii) services subscribed to by the audience.

24. A system as in claim 20 wherein the receiving unit: a) simulates placing promotional content using a projected audience and projected insertion opportunities to obtain projected results of placing the promotional content; and b) revises the received parameters based on the projected results obtained.

25. A system as in claim 20 wherein the determining unit: a) matches the received parameters against the insertion opportunities to produce a total set of matches representing possible placement of promotional content in the opportunities; and b) evaluates the produced total set of matches by using audience estimates obtained for each match to produce a selected set of matches that maximizes one or more of: i) value of the insertion opportunities, ii) targeted audience delivered to the promotional content providers for their budgets, and iii) total audience delivered to the promotional content providers for their budgets.

26. A system as in claim 20 wherein the determining unit given a total set of matches between the insertion opportunities, the received parameters, and audience estimates, selects matches that maximize one or more of: i) value of the insertion opportunities, ii) targeted audience delivered to the promotional content providers for their budgets, and iii) total audience delivered to the promotional content providers for their budgets.

27. A system as in claim 26 wherein the determining unit additionally: a) assigns values to the insertion opportunities to represent the relative values of the insertion opportunities to the promotional content providers; and b) awards a subject insertion opportunity to a subject promotional content provider so that a value of the awarded subject insertion opportunity to the subject promotional content provider is the highest amongst other insertion opportunities available.

28. A system as in claim 27 wherein the determining unit additionally assigns values to the insertion opportunities on an individual basis to represent the relative value of each insertion opportunity to the promotional content providers on an individual basis.

29. A system as in claim 27 wherein the determining unit additionally derives values from one or more of: i) reach of delivered audience, ii) relative percentage of target audience compared to other insertion opportunities, iii) expected cost of the insertion opportunities, and iv) error correction terms based on a probability that projected audiences and insertion opportunities will be available.

30. A system as in claim 20 wherein the determining unit determines which promotional content providers gain access to the insertion opportunities to place promotional content until a number of impressions paid for by each promotional content provider is reached.

31. A system as in claim 30 wherein the number of impressions includes: i) an audience who viewed promotional content placed in the insertion opportunities or ii) an audience who viewed promotional content placed in the insertion opportunities and match the received parameters.

32. A system as in claim 20 wherein the determining unit reconciles selling the insertion opportunities in terms of cost for the insertion opportunities with buying the insertion opportunities in terms of cost for a number of impressions.

33. A system as in claim 20 wherein the determining unit determines which of the insertion opportunities can be accessed by the promotional content provider to place promotional content based on one or more business rules that dictate placing promotional content into the insertion opportunities.

34. A system as in claim 20 wherein insertion opportunities are defined by one or more of: i) broadcast time, ii) broadcast channel, iii) Digital Video Recorder (DVR) slot, iv) Video on Demand (VoD) stream, v) Internet Protocol Television (IPTV) access message or vi) broadband video portal.

35. A system as in claim 20 further comprising:
a updating unit coupled the determining unit to the parameters for the negotiated transaction for access to an other insertion opportunity based on audience measurements that relate to placing promotional content in the insertion opportunity; and
the determining unit additionally re-determines based on the updated parameters for the negotiated transaction which promotional content providers gain access to the other insertion opportunities to place promotional content.

36. A system as in claim 35 wherein the updating unit updates parameters based on one or more of: i) an audience who watched the placed promotional content, ii) an audience who watched the placed promotional content and matched the received parameters, and iii) data from a third party.

37. A system as in claim 20 further comprising an accounting unit coupled to the determined unit and the receiving unit to account for placement of promotional content with one or more of: i) an audience who watched the placed promotional content, ii) an audience who watched the placed promotional content and satisfied the received parameters, and iii) data from a third party data.

38. A system as in claim 20 further comprising a second receiving unit coupled to the determining unit to receive the insertion opportunities on: i) a pre-emptible basis in which a monetary condition is set, ii) a pre-planned allocation of the insertion opportunities, or iii) a fixed monetary basis.

39. A computer program product comprising a computer readable medium having a computer readable program, wherein the computer readable program when executed on a computer causes the computer to:
receive parameters for a negotiated transaction for access to insertion opportunities from multiple promotional content providers; and
determine based on the received parameters for the negotiated transaction which promotional content providers gain access to the insertion opportunities to place promotional content.
